(19) United States
(12) Patent Application Publication
(10) Pub. No.: US 2008/0140286 A1
(43) Pub. Date: Jun. 12, 2008

(54) Parking Trace Recognition Apparatus and Automatic Parking System

(76) Inventor: Ho-Choul Jung, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/770,621

(22) Filed: Jun. 28, 2007

(30) Foreign Application Priority Data
Dec. 12, 2006 (KR) 10-2006-0125990

(51) Int. Cl. G06F 17/00

(52) U.S. Cl. 701/41; 701/1

(57) ABSTRACT

A parking trace recognition apparatus. A parking space border line extracting unit receives a signal corresponding to an image of a rear of the vehicle from a camera mounted on the vehicle, and determines a parking space border line. A mapping unit obtains a first equation of the parking space border line through three-dimensional mapping. A directional angle calculating unit calculates coordinates of the intersection between the parking space border line and the vehicle body line based on the first equation and a second equation of the vehicle body line, and calculates a directional angle of the vehicle body line with respect to the parking space border line on the basis of the coordinates of the intersection and the first and second equations. A parking trace calculating unit calculates the parking trace on the basis of a parking start position of the rear of the vehicle, and the directional angle.

### CROSS-REFERENCE TO RELATED APPLICATIONS

The present application is based on, and claims priority from, Korean Application Serial Number 10-2006-0125990, filed on Dec. 12, 2006, the disclosure of which is hereby incorporated by reference herein in its entirety.

### FIELD OF THE INVENTION

The present invention relates to an automatic parking apparatus and system, and more particularly, to an apparatus and system utilizing cameras on both side mirrors of the vehicle so as to automatically recognize parking space border lines.

### BACKGROUND OF THE INVENTION

A typical intelligent parking assistance system uses an open-loop algorithm, such that the vehicle is parked without any feedback until parking is finished. As a result, errors often occur. SUMMARY OF THE INVENTION

A parking trace recognition apparatus for determining a parking trace along which a vehicle moves during automatic parking includes a parking space border line extracting unit that receives a signal corresponding to an image of a rear of the vehicle from a camera mounted on the vehicle so as to determine a parking space border line; a three-dimensional mapping unit that obtains a first linear equation on a world coordinate of the parking space border line through three-dimensional mapping; a directional angle calculating unit that calculates coordinates of an intersection between the parking space border line and a vehicle body line on the basis of the first linear equation and a second linear equation on a world coordinate of the vehicle body line, and calculates a directional angle θ₂ of the vehicle body line with respect to the parking space border line on the basis of the calculated coordinates of the intersection and the first and second linear equations; and a parking trace calculating unit that calculates the parking trace on the basis of a parking start position xᵣ₂, yᵣ₂ of the rear of the vehicle, and the directional angle θ₂.

The parking space border line may include a lateral parking space border line and an anteroposterior parking space border line, and the parking space border line extracting unit may extract the lateral parking space border line before automatic parking occurs and subsequently extract the anteroposterior parking space border line.

The parking trace may include an arc section that extends from the parking start position xᵣ₂, yᵣ₂ and a linear section that extends from the end of the arc section. The radius of curvature Rₒₚₜ of the arc section may be

$${R}_{opt} = \frac{{x}_{r 2}}{1 - sin {θ}_{2}}$$

An automatic parking system may include a parking trace recognition apparatus; and a steering control unit that calculates a steering command angle

$${φ}_{opt} = {tan}^{- 1} [ \frac{l}{{R}_{opt}} ] = {tan}^{- 1} [ \frac{l ( 1 - sin {θ}_{2} )}{{x}_{r 2}} ] ,$$

where l is a distance between front and rear wheel shafts in the vehicle, corresponding to the calculated parking trace, and controls steering of the vehicle according to the steering command angle φₒₚₜ such that the vehicle moves along the parking trace. The parking trace may be recalculated during the steering control.

If the intersection between the vehicle body line and the parking space border line is not extracted while the vehicle moves along the parking trace, the steering control unit may control the steering command angle by determining whether or not the anteroposterior parking space border line and the vehicle body line are parallel with each other on the basis of the image signal, and if the anteroposterior parking space border line and the vehicle body line are parallel, the steering control unit may stop the steering control.

### BRIEF DESCRIPTION OF THE DRAWINGS

For a better understanding of the nature and objects of the present invention, reference should be made to the following detailed description with the accompanying drawings, in which:

FIG. 1 is a schematic diagram of an automatic parking system 10 according to an embodiment of the present invention;

FIG. 2 is a diagram showing a process of calculating a directional angle of a vehicle according to an embodiment of the present invention;

FIG. 3 is a conceptual view of three-dimensional mapping according to an embodiment of the present invention;

FIG. 4 is a diagram illustrating calculation of an additional trace according to an embodiment of the present invention;

FIG. 5 is a flowchart of an automatic parking method according to an embodiment of the present invention; and

FIG. 6 is a schematic diagram showing an automatic parking process according to the flowchart of FIG. 5.

### DETAILED DESCRIPTION OF THE PREFERRED EMBODIMENTS

Hereinafter, preferred embodiments of the present invention will be described with reference to the accompanying drawings.

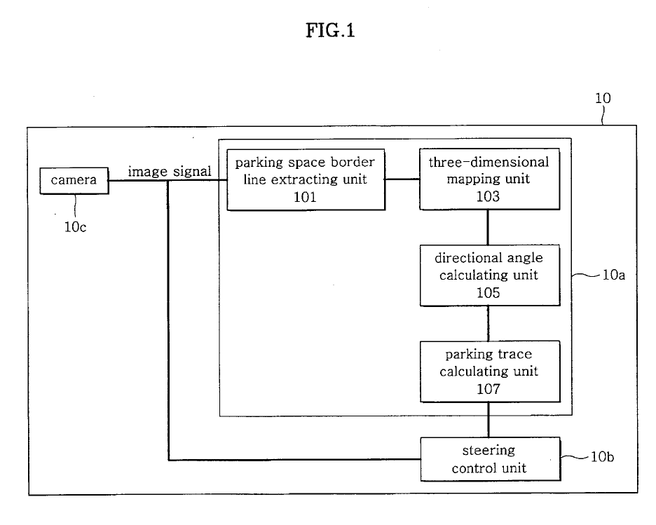

Referring to FIG. 1, a system 10 includes a camera 10c, a steering control unit 10b, and a parking trace recognition apparatus 10a including a parking space border line extracting unit 101, a three-dimensional mapping unit 103, a directional angle calculating unit 105, and a parking trace calculating unit 107.

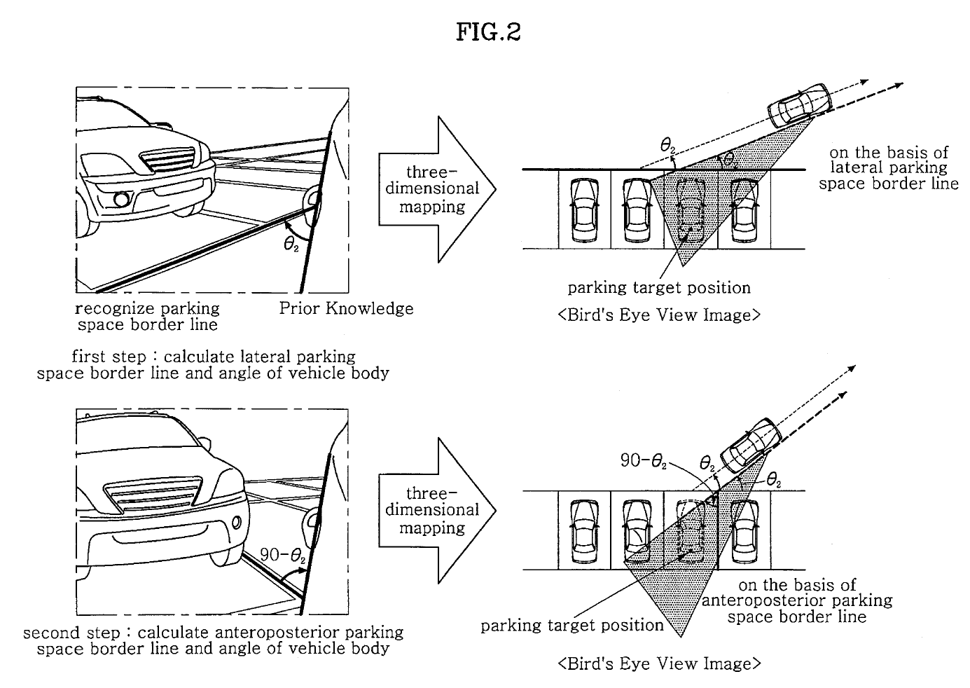

Parking space border line extracting unit 101 receives images, taken at the rear of a vehicle by cameras mounted on side mirrors of the vehicle, calculates an optimum threshold value according to Otsu's method, and extracts a lateral parking space border line and an anteroposterior parking space border line as described below. In more detail, parking space border line extracting unit 101 first detects the lateral parking space border line at the beginning of automatic parking (“first step” of FIG. 2). Then, if it becomes difficult to detect the lateral parking space border line while the vehicle is being automatically parked, parking space border line extracting unit 101 detects an anteroposterior parking space border line (“second step” of FIG. 2).

Three-dimensional mapping unit 103 performs three-dimensional mapping of the parking space border lines extracted by parking space border line extracting unit 10 so as to obtain world coordinates, and obtains a linear equation by applying regression to the individual coordinates. The linear equation is a set of coordinates with respect to the lateral/anteroposterior parking space border line actually having a linear shape. Meanwhile, since a line in a longitudinal direction of the vehicle (hereinafter, simply referred to as a “vehicle body line”) has a fixed position with respect to the camera, a linear equation of the vehicle body line is known.

Directional angle calculating unit 105 calculates the position of the intersection between the vehicle body line and the parking space border line on the basis of the linear equation obtained by three-dimensional mapping unit 103 and the linear equation of the vehicle body line, and then calculates a directional angle θ₂ of the vehicle body line with respect to the parking space border lines. As seen in FIG. 2, θ₂ is the angle between the vehicle body line and the lateral parking space border line. θ₂ may be obtained by subtracting the angle between the anteroposterior parking space border line and the vehicle body line from 90°.

Parking trace calculating unit 107 calculates a parking trace by using the initial position and the information on the directional angle θ₂ of the vehicle calculated by calculating unit 105, as described below.

Steering control unit 10c performs steering control of the vehicle such that the vehicle is automatically parked along the parking trace calculated by parking trace calculating unit 107. Further, steering control unit 10b determines whether or not the anteroposterior parking space border line and the vehicle body line are parallel with each other (for example, when the two lines have the same slope, it is determined that the two lines are parallel) on the basis of the image signals acquired by camera 10c in a linear section where an intersection between the vehicle body line and the parking space border line is no longer extracted. Then, steering control unit 10b controls a steering angle, thereby performing automatic parking.

Automatic parking system 10 continuously receives images of the rear of the vehicle, during steering control, from parking space border line extracting unit 101, and repeats the above-described process.

Hereinafter, a method of calculating a parking trace using a closed loop through three-dimensional mapping of a parking space border line will be described.

FIG. 2 shows a process of extracting a lateral parking space border line from the images at the rear of the vehicle captured by the cameras mounted on the side mirrors by parking space border line extracting unit 101, performing three-dimensional mapping of the extracted lateral parking space border line by three-dimensional mapping unit 103, and calculating the directional angle θ₂ of the vehicle with respect to the lateral parking space border line by calculating unit 105.

FIG. 2 shows a process of extracting an anteroposterior parking space border line from the images at the rear of the vehicle captured by the cameras mounted on the side mirrors by parking space border line extracting unit 101, performing three-dimensional mapping of the extracted anteroposterior parking space border line by three-dimensional mapping unit 103, and calculating a directional angle of (90°-θ₂) of the vehicle with respect to the anteroposterior parking space border line by calculating unit 105.

Hereinafter, an example for three-dimensional mapping that is performed by three-dimensional mapping unit 103 will be described. Various schemes that are generally used for camera calibration may be used. For exemplary purposes only, three-dimensional mapping using Tsai's algorithm (also referred to as Tsai's camera model) will be described.

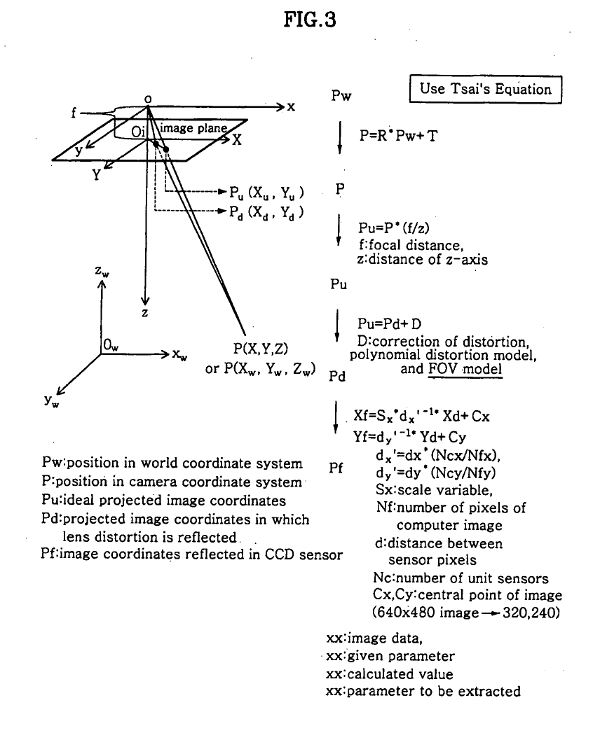

FIG. 3 is a conceptual view illustrating a process in which three-dimensional mapping is performed on the images captured by the camera so as to obtain an image coordinate reflected in a CCD sensor of the camera. In FIG. 3, a position Pw represented in a world coordinate system, a position P in a camera coordinate system, ideal projected image coordinates Pu, projected image coordinates Pd, in which lens distortion is reflected, and image coordinates Pf reflected in the CCD sensor of the camera are sequentially obtained according to individual equations.

That is, the world coordinates Pw are converted into the camera coordinates P according to rotation-translation as follows.

$$( {x}_{w} , {y}_{w} , 0 ) {}^{R , T} ( {x}_{c} , {y}_{c} , {z}_{c} ) \\ [ \begin{matrix}x \\ y \\ z\end{matrix} ] = R [ \begin{matrix}{x}_{w} \\ {y}_{w} \\ {z}_{w}\end{matrix} ] + T$$

R denotes a 3×3 rotation matrix, and T denotes a translation vector. As the values of R and T, result values are provided using a calibration program.

Then, the camera coordinates P are converted into the ideal image coordinates Pu as follows

$$( {x}_{c} , {y}_{c} , {z}_{c} ) {}^{f} ( {x}_{u} , {y}_{u} )$$

$${X}_{u} = f \frac{x}{z} , {Y}_{u} = f \frac{y}{z}$$

As the value of f (focal distance), a result value is provided using the calibration program.

Then, the ideal image coordinates Pu are converted into the projected image coordinates Pd, in which lens distortion is reflected, as follows.

$$( {x}_{u} , {y}_{u} ) {}^{{k}_{1} , {k}_{2} , w} ( {x}_{d} , {y}_{d} )$$

$${X}_{d} + {D}_{x} = {X}_{u} , {D}_{x} = {X}_{d} ( {k}_{1} {r}^{2} + {k}_{2} {r}^{4} + … )$$

$${Y}_{d} + {D}_{y} = {Y}_{u} , {D}_{y} = {Y}_{d} ( {k}_{1} {r}^{2} + {k}_{2} {r}^{4} + … )$$

$$r = \sqrt{{X}_{d}^{2} + {Y}_{d}^{2}}$$

Here, k₁ and k₂ denote lens distortion constants, and X_{d} and Y_{d} denote image coordinates in an actual image plane.

In the case of a fisheye lens having large distortion, both a polynomial distortion model and an FOV model are applied.

$${r}_{d} -> {r}_{d}^{′} -> {r}_{u} , {r}_{x}^{′} = {r}_{d} ( {k}_{1} {r}_{d}^{2} + {k}_{2} {r}_{d}^{4} + L )$$

$${r}_{u} = \frac{tan ( {r}_{d}^{′} w )}{2 tan \frac{w}{2}}$$

As the values of k₁, k₂, and w, result values are provided using the calibration program.

Finally, the actual image coordinates Pd are converted into the digital image coordinates Pf.

$$( {x}_{d} , {y}_{d} ) -> ( {x}_{f} , {y}_{f} )$$

$${X}_{f} = {s}_{x} {d}_{x}^{′ - 1} {X}_{d} + {C}_{x}$$

$${Y}_{f} = {d}_{x}^{′ - 1} {Y}_{d} + {C}_{y}$$

$${d}_{x}^{′} = {d}_{x} \frac{{N}_{cx}}{{N}_{vx}} , {d}_{y}^{′} = {d}_{y} \frac{{N}_{cy}}{{N}_{fy}}$$

Here, (Cₓ, C_{y}) denotes coordinates of a center point of a digital image, Sₓ denotes a scale variable, N_{cx} and N_{cy} denote numbers of unit sensors in the X and Y directions, respectively, dₓ and d_{y} denote distances between adjacent unit sensors in the X and Y directions, respectively, and N_{fx} and N_{fy} denote numbers of pixels of a computer image in the X and Y directions, respectively.

On the basis of the linear equation of the parking space border line calculated through three-dimensional mapping and the prescribed linear equation of the vehicle body line, directional angle calculating unit 105 calculates the initial position of the intersection between the parking space border line and the vehicle body line, and the directional angle θ₂ of the vehicle body line with respect to the lateral parking space border line. On the basis of the calculation result, parking trace calculating unit 107 calculates a parking trace, as described below.

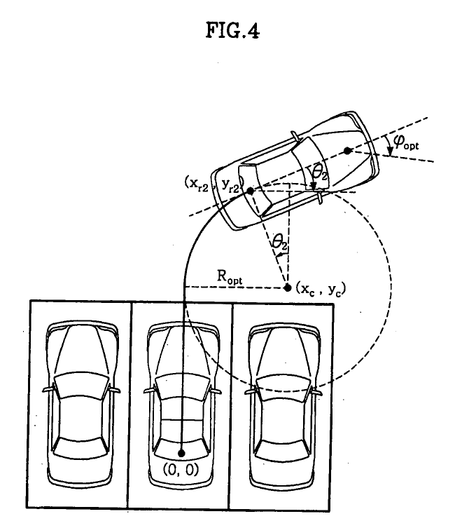

Referring to FIG. 4, the parking trace generally includes an arc section and a linear section. For the vehicle to be parked at the target position regardless of the parking start position and the directional angle, the center of curvature (x_{c}, y_{c}) of the arc section and the contact point between the arc section and the linear section need to be obtained based on the parking start position and the directional angle θ₂ as follows. At this time, as shown in FIG. 4, the parking start position is previously set to a predetermined point (xᵣ₂, yᵣ₂) at the rear of the vehicle.

$$( {x}_{c} , {y}_{c} ) = ( {x}_{r 2} + {R}_{opt} sin {θ}_{2} , {y}_{r 2} - {R}_{opt} cos {θ}_{2} )$$

$${x}_{r 2} + {R}_{opt} sin {θ}_{2} = {R}_{opt} -> {R}_{opt} = \frac{{x}_{r 2}}{1 - sin {θ}_{2}}$$

where Rₒₚₜ is the radius of curvature of the arc section.

In the arc section, a constant steering command angle φₒₚₜ that is determined according to the parking start position and the directional angle θ₂ is used. The steering command angle is calculated by the following equation. Here, l denotes a wheel base (a distance between front and rear wheel shafts in the vehicle).

$${R}_{opt} = \frac{l}{tan {φ}_{opt}} -> {φ}_{opt} = {tan}^{- 1} [ \frac{l}{{R}_{opt}} ] = {tan}^{- 1} [ \frac{l ( 1 - 0 sin {θ}_{2} )}{{x}_{r 2}} ]$$

Therefore, steering control unit 10b sets a steering angle of the vehicle by the steering command angle φₒₚₜ, such that automatic parking of the vehicle is performed. In order to update the directional angle that is changed while automatic parking is performed, the operations of parking space border line extracting unit 101 to steering control unit 10b are repeated.

Meanwhile, in the linear section, it is determined whether or not the anteroposterior parking space border line and the vehicle body line are parallel with each other on the basis of the images acquired by camera 10c, thereby controlling the steering command. When the anteroposterior parking space border line and the vehicle body line are parallel, the steering control is interrupted. Then, parking is manually finished by the driver.

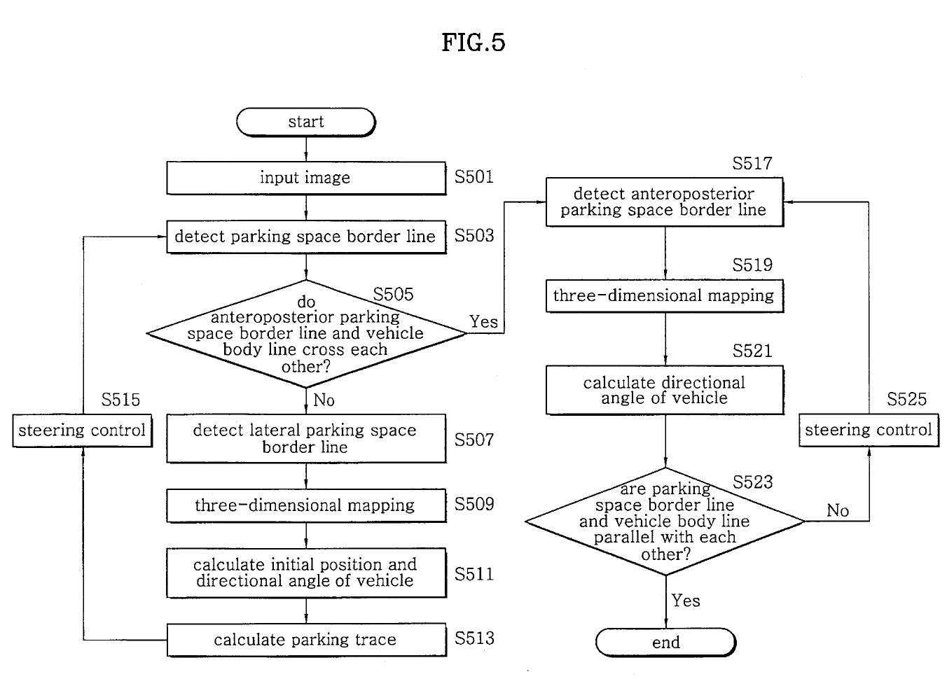

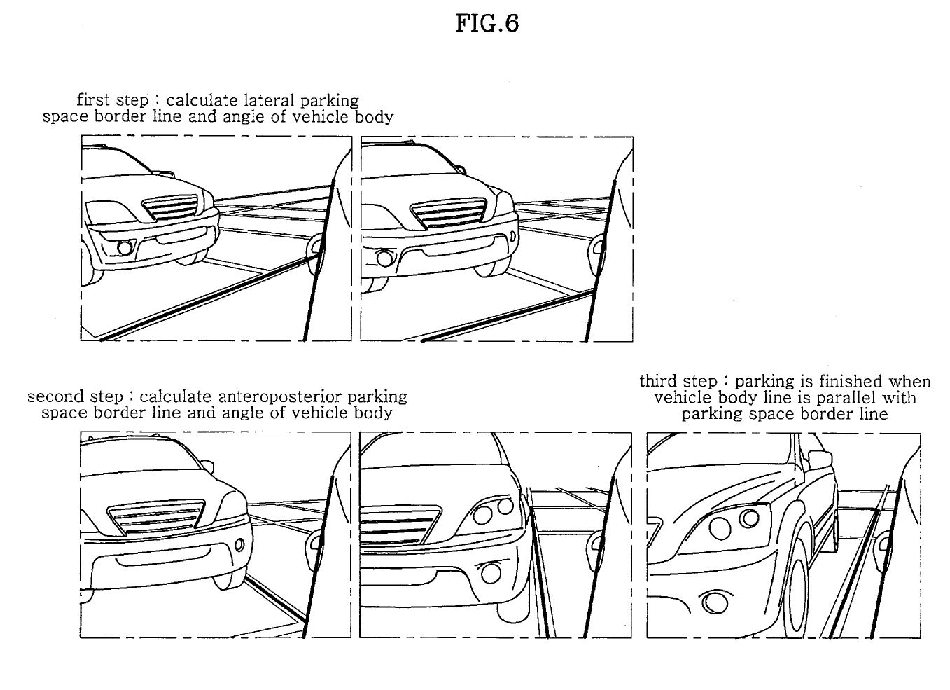

Hereinafter, an automatic parking method according to an embodiment of the present invention will be described with reference to FIGS. 5 and 6.

Parking space border line extracting unit 101 acquires the image signals at the rear of the vehicle from camera 10c at the beginning of parking of the vehicle (Step S501). Next, the lateral/anteroposterior parking space border line is extracted on the basis of the image signals (Step S503). Next, it is detected whether or not the anteroposterior parking space border line crosses the vehicle body line (Step S505). If it does not, the lateral parking space border line is detected (Step S507).

Three-dimensional mapping unit 103 uses a three-dimensional method on the basis of the lateral parking space border line detected at Step S507 so as to obtain the linear equations of the lateral parking space border line and the vehicle body line (Step S509).

On the basis of the linear equations obtained in Step S509, directional angle calculating unit 105 calculates the initial position and the directional angle θ₂ at the intersection between the lateral parking space border line and the vehicle body line (Step S511)

On the basis of the directional angle θ₂ calculated at Step S511 and the parking start position arbitrarily set to a predetermined portion of the vehicle, parking trace calculating unit 107 calculates a parking trace for automatic parking (Step S513).

On the basis of the parking trace calculated at Step S513, steering control unit 10b sets a steering angle of the vehicle by the steering command angle φₒₚₜ so as to perform automatic parking of the vehicle (Step S515). Then, in order to update the directional angle that is changed while automatic parking is performed, Steps S503 to S515 are repeated (“first step” of FIG. 6).

Meanwhile, when it is determined that the anteroposterior parking space border line and the vehicle body line cross each other at Step S505, Steps S517, S519, and S521 are sequentially performed. Next, steering control unit 10b determines whether or not the parking space border line and the vehicle body line are parallel with each other (Step S523). If steering control unit 10b determines that the two lines are not parallel, the process proceeds to Step S525, and Steps S517 to 523 are repeated. If it is determined that the two lines are parallel, automatic parking is finished. When the steering control ends, the user manually parks the vehicle (“second step” and “third step” of FIG. 6).

According to the above embodiments of the present invention, a parking trace is generated through three-dimensional mapping of a parking space border line and geometrical analysis of a vehicle, and the parking trace is updated in real time through recognition of lateral/anteroposterior parking space border lines and estimation of a directional angle with respect to a vehicle body line. Therefore, it is possible to prevent errors during automatic parking.

According to the above embodiments of the present invention, when parking is finished, it is checked whether or not the anteroposterior parking space border line and the vehicle body line are parallel through image processing. Therefore, accurate automatic parking can be realized.

According to the above embodiments of the present invention, a parking location is automatically recognized without user intervention, thereby improving convenience of automatic parking.

Although the preferred embodiments of the present invention have been disclosed for illustrative purposes, those skilled in the art will appreciate that various modifications, additions and substitutions are possible, without departing from the scope and spirit of the present invention as disclosed in the accompanying claims.

What is claimed is:

1. A parking trace recognition apparatus for determining a parking trace along which a vehicle moves during automatic parking, comprising:
a parking space border line extracting unit that receives a signal corresponding to an image of a rear of the vehicle from a camera mounted on the vehicle so as to determine a parking space border line;
a three-dimensional mapping unit that obtains a first linear equation on a world coordinate of the parking space border line through three-dimensional mapping;
a directional angle calculating unit that calculates coordinates of an intersection between the parking space border line and a vehicle body line on the basis of the first linear equation and a second linear equation on a world coordinate of the vehicle body line, and calculates a directional angle θ₂ of the vehicle body line with respect to the parking space border line on the basis of the calculated coordinates of the intersection and the first and second linear equations; and
a parking trace calculating unit that calculates the parking trace on the basis of a parking start position xᵣ₂, yᵣ₂ of the rear of the vehicle, and the directional angle θ₂.

2. The apparatus as set forth in claim 1, wherein the parking space border line comprises a lateral parking space border line and an anteroposterior parking space border line, and the parking space border line extracting unit extracts the lateral parking space border line before automatic parking occurs and subsequently extracts the anteroposterior parking space border line.

3. The apparatus as set forth in claim 1, wherein the parking trace comprises an arc section that extends from the parking start position xᵣ₂, yᵣ₂ and a linear section that extends from an end of the arc section, and a radius of curvature Rₒₚₜ of the arc section is
$${R}_{opt} = \frac{{x}_{r 2}}{1 - sin {θ}_{2}}$$

4. An automatic parking system comprising:
a parking trace recognition apparatus for determining a parking trace along which a vehicle moves during automatic parking, comprising:
a parking space border line extracting unit that receives a signal corresponding to an image of a rear of the vehicle from a camera mounted on the vehicle so as to determine a parking space border line;
a three-dimensional mapping unit that obtains a first linear equation on a world coordinate of the parking space border line through three-dimensional mapping;
a directional angle calculating unit that calculates coordinates of an intersection between the parking space border line and a vehicle body line on the basis of the first linear equation and a second linear equation on a world coordinate of the vehicle body line, and calculates a directional angle θ₂ of the vehicle body line with respect to the parking space border line on the basis of the calculated coordinates of the intersection and the first and second linear equations; and
a parking trace calculating unit that calculates the parking trace on the basis of a parking start position xᵣ₂, yᵣ₂ of the rear of the vehicle, and the directional angle θ₂, wherein the parking trace comprises an arc section that extends from the parking start position xᵣ₂, yᵣ₂ and a linear section that extends from an end of the arc section, and a radius of curvature Rₒₚₜ of the arc section is
$${R}_{opt} = \frac{{x}_{r 2}}{1 - sin {θ}_{2}} ;$$
and
a steering control unit that calculates a steering command angle
$${φ}_{opt} = {tan}^{- 1} [ \frac{l}{{R}_{opt}} ] = {tan}^{- 1} [ \frac{l ( 1 - sin {θ}_{2} )}{{x}_{r 2}} ] ,$$
where l is a distance between front and rear wheel shafts in the vehicle, corresponding to the calculated parking trace, and controls steering of the vehicle according to the steering command angle opt such that the vehicle moves along the parking trace;
wherein the parking trace is recalculated during the steering control.

5. The system as set forth in claim 4, wherein the parking space border line comprises a lateral parking space border line and an anteroposterior parking space border line, and wherein if the intersection between the vehicle body line and the parking space border line is not extracted while the vehicle moves along the parking trace, the steering control unit controls the steering command angle by determining whether or not the anteroposterior parking space border line and the vehicle body line are parallel with each other on the basis of the image signal, and if the anteroposterior parking space border line and the vehicle body line are parallel, the steering control unit stops the steering control.
